(19) United States
(12) Patent Application Publication
(10) Pub. No.: US 2024/0270597 A1
(43) Pub. Date: Aug. 15, 2024

(54) OXYGEN ION TRANSPORT MATERIALS AND RELATED DEVICES

(71) Applicant: Wisconsin Alumni Research Foundation, Madison, WI (US)

(72) Inventors: Dane Morgan, Middleton, WI (US); Jun Meng, Madison, WI (US); Ryan Matthew Jacobs, Middleton, WI (US)

(21) Appl. No.: 18/565,772

(22) PCT Filed: Jun. 14, 2022
(86) PCT No.: PCT/US22/72916

§ 371 Date: Nov. 30, 2023

Related U.S. Application Data
(60) Provisional application No. 63/210,560, filed on Jun. 15, 2021.

(51) Int. Cl. C01G 45/00; C01B 13/02

(52) U.S. Cl. CPC C01G 45/006; C01B 13/0203

(57) ABSTRACT

Devices are provided, which in embodiments, comprise a source configured to generate oxygen ions via a redox reaction; and an oxygen ion transport material through which oxygen ions generated from the source are transported. The oxygen ion transport material may have either: Formula I A^{x+}B₂^{y+}C₄^{z+}O₁₂ ²⁻ wherein x+2y+4z=24 and (x, y, z) is (4, 2, 4), (x, y, z) is (2, 1, 5), or (x, y, z) is (3, 2.5, 4); Formula II A₄^{x+}B₅^{y+}C₄^{z+}O₂₂²⁻ wherein 4x+5y+4z=44 and (x, y, z) is (2, 4, 4) or (x, y, z) is (3, 3.2, 4) or (x, y, z) is (2.5, 3.6, 4); or Formula III Bi₂MO₄X; wherein A, B, and C are independently selected from alkali metals, alkaline earth metals, transition metals, post-transition metals, metalloids, lanthanoids, P, Th, and combinations thereof, and wherein M is selected from rare earth elements and combinations thereof and X is selected from halogens and combinations thereof. Methods of using the devices are also provided, which in embodiments, which comprise transporting oxygen ions generated from the source through the oxygen ion transport material.

### CROSS-REFERENCE TO RELATED APPLICATIONS

The present application claims priority to U.S. provisional patent application No. 63/210,560 that was filed Jun. 15, 2021, the entire contents of which are incorporated herein by reference.

### REFERENCE TO GOVERNMENT RIGHTS

This invention was made with government support under DE-SC0020419 awarded by the US Department of Energy. The government has certain rights in the invention.

### BACKGROUND

Materials which rapidly conduct oxygen are useful for a variety of devices such as solid-oxide fuel cells, gas sensors, catalysts, and oxygen separation membranes. However, fast oxygen conductor materials are concentrated in only a handful of materials families, including perovskites, fluorites, Ruddlesden-Poppers, and apatites. Of these, even fewer are known to conduct oxygen via an interstitial-mediated mechanism. Only some Ruddlesden-Popper materials, some apatites, and UO₂₊ₓ are known to exhibit significant interstitial oxygen ion transport.

### SUMMARY

The present disclosure is based, at least in part, on the inventors' discovery of new materials exhibiting fast oxygen ion transport, even at low temperatures (e.g., less than 500° C.). Some materials have been found to exhibit oxygen diffusivities sufficiently fast to enable rapid oxygen ion transport at room temperature. As such, the present materials may be used to transport oxygen ions in a variety of devices, e.g., fuel cells, supercapacitors, gas sensors, separation systems, catalysts, metal-air batteries, and steam reactors.

Devices are provided, which in embodiments, comprise a source configured to generate oxygen ions via a redox reaction; and an oxygen ion transport material through which oxygen ions generated from the source are transported. The oxygen ion transport material may have either: Formula I A^{x+}B₂^{y+}C₄^{z+}O₁₂ ²⁻ wherein x+2y+4z=24 and (x, y, z) is (4, 2, 4), (x, y, z) is (2, 1, 5), or (x, y, z) is (3, 2.5, 4); Formula II A₄^{x+}B₅^{y+}C₄^{z+}O₂₂²⁻ wherein 4x+5y+4z=44 and (x, y, z) is (2, 4, 4) or (x, y, z) is (3, 3.2, 4) or (x, y, z) is (2.5, 3.6, 4); or Formula III Bi₂MO₄X; wherein A, B, and C are independently selected from alkali metals, alkaline earth metals, transition metals, post-transition metals, metalloids, lanthanoids, P, Th, and combinations thereof, and wherein M is selected from rare earth elements and combinations thereof and X is selected from halogens and combinations thereof.

Methods of using the devices are also provided, which in embodiments, which comprise transporting oxygen ions generated from the source through the oxygen ion transport material.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1B depict the bulk structure of ZrMn₂Ge₄O₁₂ viewed from (FIG. 1A) and (FIG. 1B) [001].

FIG. 2 depicts the bulk structure of La₄Mn₅Si₄O₂₂. The black box denotes a single unit cell, and four unit cells are shown to aid visibility of the structure.

FIGS. 3A-3D demonstrate oxygen ion migration through ZrMn₂Ge+O₁₂ (FIG. 3A) and La₄30 Mn₅Si₄O₂₂ (FIG. 3C). The migration pathway is marked by arrows. The initial and final sites of the oxygen interstitial are labeled in FIGS. 3A and 3C. The lattice oxygen participating in the migration pathway are labeled in FIG. 3A. FIGS. 3B and 3D show the nudged elastic band (NEB) calculated energy profile along the migration pathway of oxygen ion in ZrMn₂Ge₄O₁₂ and La₄Mn₅Si₄O₂₂, respectively.

FIGS. 4A-4B show Arrhenius plot of oxygen ion diffusivity versus the reciprocal of the temperature in (FIG. 4A) ZrMn₂Ge₄O₁₂ and (FIG. 4B) La₄Mn₅Si₄O₂₂ from ab initio molecular dynamics (AIMD) simulations.

FIG. 5 depicts a schematic of a fuel cell comprising an oxygen ion transport material according to an illustrative embodiment.

FIG. 6 depicts a schematic of a metal-air battery comprising an oxygen ion transport material according to an illustrative embodiment.

FIG. 7 depicts a schematic of a gas sensor comprising an oxygen ion transport material according to an illustrative embodiment.

FIG. 8 depicts a schematic of a separation system comprising an oxygen ion transport material according to an illustrative embodiment.

FIG. 9 depicts a schematic of a supercapacitor comprising an oxygen ion transport material according to an illustrative embodiment.

FIG. 10 depicts a schematic of a steam reactor for carrying out solid oxide electrolysis comprising an oxygen ion transport material according to an illustrative embodiment.

FIGS. 11A-11B depict the bulk structure of Bi₂LaO₄Cl from side (FIG. 11A) and top (FIG. 11B) view.

FIG. 12A demonstrates oxygen ion migration through Bi₂LaO₄Cl. The migration pathway is marked by arrows. The initial and final sites of the oxygen are labeled in FIG. 12A. FIG. 12B shows the nudged elastic band (NEB) calculated energy profile along the migration pathway of oxygen ion in Bi₂LaO₄Cl.

FIG. 13 shows Arrhenius plot of oxygen ion diffusivity versus the reciprocal of the temperature in Bi₂LaO₄Cl from ab initio molecular dynamics (AIMD) simulations with 2.78% of oxygen sites vacant in the cell.

FIGS. 14A-14C show the X-ray powder diffraction patterns of ZrMn₂Ge₄O₁₂ (FIG. 14A), La₄Mn₅Si₄O₂₂ (FIG. 14B), and Bi₂LaO₄Cl (FIG. 14C).

FIGS. 15A-15B show the electrical conductivity transient of the ZrMn₂Ge₄O₁₂ pellet as the oxygen partial pressure goes from 5% to 20% atm (FIG. 15A) and from 20% to 5% atm (FIG. 15B) at a temperature of 775° C.

FIGS. 16A-16B shows the electrical conductivity transient of the La₄Mn₅Si₄O₂₂ pellet as the oxygen partial pressure goes from 5% to 20% atm (FIG. 16A) and from 20% to 5% atm (FIG. 16B) at a temperature of 800° C.

FIGS. 17A-17B shows the electrical conductivity transient of the Bi₂LaO₄Cl pellet as the oxygen partial pressure goes from 10% to 20% atm (FIG. 17A) and from 20% to 10% atm (FIG. 17B) at a temperature of 600° C.

FIGS. 18A-18B show the fitting of the normalized electrical conductivity relaxation curve of ZrMn₂Ge₄O₁₂ with oxygen partial pressure changing from 5% to 20% at 750° C. (FIG. 18A) and the fitting of the normalized electrical conductivity relaxation curve of La₄Mn₅Si₄O₂₂ with oxygen partial pressure changing from 5% to 20% at 800° C. (FIG. 18B).

### DETAILED DESCRIPTION

Provided are oxygen ion transport materials, devices comprising the materials, and methods of using the materials and devices.

AB₂C₄O₁₂ Materials

Embodiments of the oxygen ion transport materials have Formula I A^{x+}B₂^{y+}C₄^{z+}O₁₂²⁻ wherein x+2y+4z=24. The labels A, B, and C, represent distinct lattice sites in the material which are occupied by various elements. The A-site elements, B-site elements, and C-site elements are selected to satisfy the valence equation x+2y+4z=24. In embodiments, the valence configuration (x, y, z) is (4, 2, 4), i.e. A⁴⁺B₂²⁺C₄⁴⁺O₁₂²⁻ (Formula IA). In embodiments, the valence configuration (x, y, z) is (2, 1, 5), i.e., A²⁺B₂¹⁺C₄⁵⁺O₁₂²⁻ (Formula IB). In embodiments, the valence configuration (x, y, z) is (3, 2.5, 4), i.e., A³⁺B₂^{2.5+}C₄⁴⁺O₁₂²⁻ (Formula IC). In general, the A-site, B-site, and C-site elements may be selected from alkali metals, alkaline earth metals, transition metals, post-transition metals, metalloids, and lanthanoids. In embodiments, a reactive non-metal such as P may be used, e.g., for a C-site element. Unless otherwise stated, more than one type of element may be present on a particular site. This includes, e.g., having 2, 3, 4, 5, 6, 7, etc. different types of elements on the A-site, the B-site, the C-site, or combinations thereof.

In embodiments, a single type of element is present on the A-site, one or two types of elements are present on the B-site, and a single type of element is present on the C-site. In embodiments, a single type of element is present on the A-site, a single type of element is present on the B-site, and a single type of element is present on the C-site.

Table 1, below, includes embodiments of oxygen ion transport materials having Formulas IA, IB, or IC which may be used. In embodiments, the oxygen ion transport material has Formula IA, wherein A is selected from Ti, Zr, Hf, Ce, Re, Ir, and combinations thereof; B is selected from Mg, Ca, Sr, Ba, Mn, Fe, Co, Ni, Cu, and combinations thereof; and C is selected from Si, Ge, Sn, and combinations thereof. In embodiments, the oxygen ion transport material has Formula IB, wherein A is selected from Mg, Ca, Sr, Ba, Cu, Zn, and combinations thereof; B is selected from Li, Na, K, Rb, Cs, Ag, and combinations thereof; and C is selected from V, Nb, Ta, P, As, Sb, and combinations thereof. In embodiments, the oxygen ion transport material has Formula IC, wherein A is selected from Al, Ga, Sc, Y, La, Ce, Pr, Nd, Sm, Eu, Gd, Tb, Dy, Ho, Er, Tm, Yb, Lu, and combinations thereof; B is selected from a combination of at least one A-site element and at least one of Mg, Ca, Sr, Ba, Mn, Fe, Co, Ni, Cu, and Zn; and a combination of at least two of Mg, Ca, Sr, Ba, Mn, Fe, Co, Ni, Cu, Zn; and C is selected from Si, Ge, Sn, and combinations thereof.

TABLE 1
Embodiments of oxygen ion transport materials having Formula IA, IB, or IC.

| Material | A-site elements | B-site elements | C-site elements |
|---|---|---|---|
| A⁴⁺B₂²⁺C₄⁴⁺O₁₂²⁻ | Ti, Zr, Hf, Ce, Re, | Mg, Ca, Sr, Ba, Mn, | Si, Ge, Sn |
| (Formula IA) | Ir | Fe, Co, Ni, Cu | |
| A²⁺B₂¹⁺C₄⁵⁺O₁₂²⁻ | Mg, Ca, Sr, Ba, | Li, Na, K, Rb, Cs, Ag | V, Nb, Ta, P, As, |
| (Formula IB) | Cu, Zn | | Sb |
| A³⁺B₂^{2.5+}C₄⁴⁺O₁₂²⁻ | Al, Ga, Sc, Y, La, | An element in A-site | Si, Ge, Sn |
| (Formula IC) | Ce, Pr, Nd, Sm, | column + one of Mg, | |
| | Eu, Gd, Tb, Dy, | Ca, Sr, Ba, Mn, Fe, Co, | |
| | Ho, Er, Tm, Yb, | Ni, Cu, Zn; or two of | |
| | Lu | Mg, Ca, Sr, Ba, Mn, | |
| | | Fe, Co, Ni, Cu, Zn | |

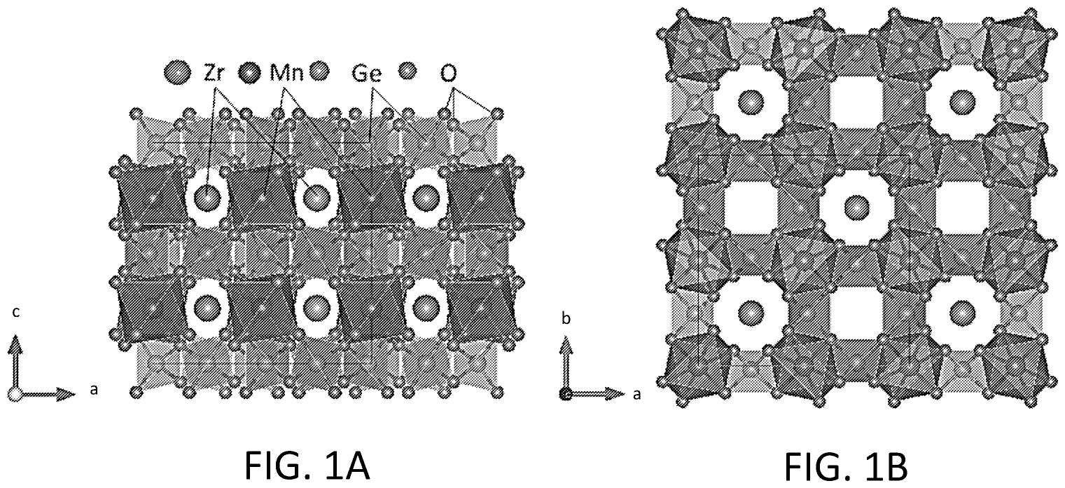

In embodiments, the oxygen ion transport material has Formula IA, wherein A is selected from Zr, Ce, and combinations thereof; B is selected from Mn, Co, Ni, Cu, and combinations thereof; and C is Ge. In embodiments, the oxygen ion transport material has Formula IA, wherein A is selected from Zr, Ce, and combinations thereof; B is selected from Mn, Co, and combinations thereof; and C is Ge. In embodiments, the oxygen ion transport material has Formula IB, wherein A is selected from Ca, Sr, and combinations thereof; B is selected from Na, K, Rb, Cs, Ag, and combinations thereof; and C is selected from V, P, As, and combinations thereof. In embodiments, the oxygen ion transport material has Formula IC, wherein A is selected from Y, Eu, Gd, Dy, Ho, Er, Tm, Yb, Lu, Tb, Ce, Pr, and combinations thereof; B is selected from a combination of at least one A-site element and at least one of Ca, Mn, and Co; and a combination of at least two of Ca, Mn, Fe, Co, Cu, Sc and Zn; and C is Ge. An illustrative list of such species is shown in Table 2, below. The materials of Table 2 have been experimentally synthesized and confirmed to share similar crystal structure (although not necessarily same space group) as ZrMn₂Ge₄O₁₂ (see FIGS. 1A and 1B).

TABLE 2
Additional embodiments of oxygen ion transport
materials having Formula IA, IB, or IC.
Formula IA (A⁴⁺B₂²⁺C₄⁴⁺O₁₂²⁻)
Ce(MnₓCo₂₋ₓ)Ge₄O₁₂(x = 0, 0.5, 1, 1.5, 2)
Zr(MnₓCo₂₋ₓ)Ge₄O₁₂ (x = 0, 0.5, 1, 1.5, 2)
Ce(Mn_{1.5}Ni_{0.5})Ge₄O₁₂
Ce(Mn_{1.5}Cu_{0.5})Ge₄O₁₂
Ce(Co_{1.5}Ni_{0.5})Ge₄O₁₂
Ce(Co_{1.5}Cu_{0.5})Ge₄O₁₂
Formula IB (A²⁺B₂¹⁺C₄⁵⁺O₁₂²⁻)
CaNa₂As₄O₁₂
CaAg₂V₄O₁₂
CaNa₂V₄O₁₂
SrAg₂V₄O₁₂
SrNa₂V₄O₁₂
SrK₂V₄O₁₂
SrRb₂V₄O₁₂
SrNa₂P₄O₁₂
CaNa₂P₄O₁₂
SrCs₂V₄O₁₂
Formula IC (A³⁺B₂^{2.5+}C₄⁴⁺O₁₂²⁻)
Er(FeCu)Ge₄O₁₂
Eu(EuMn)Ge₄O₁₂
Gd(GdMn)Ge₄O₁₂
Dy(DyMn)Ge₄O₁₂
Ho(HoMn)Ge₄O₁₂
Er(ErMn)Ge₄O₁₂
Tm(TmMn)Ge₄O₁₂
Yb(YbMn)Ge₄O₁₂
Lu(LuMn)Ge₄O₁₂
Y(YMn)Ge₄O₁₂
Gd(GdCo)Ge₄O₁₂
Tb(TbCo)Ge₄O₁₂
Dy(DyCo)Ge₄O₁₂
Ho(HoCo)Ge₄O₁₂
Er(ErCo)Ge₄O₁₂
Gd(LuCo)Ge₄O₁₂
Gd(ScCo)Ge₄O₁₂
Tb(ScCo)Ge₄O₁₂
Dy(ScCo)Ge₄O₁₂
Y(YCo)Ge₄O₁₂
Eu(EuCa)Ge₄O₁₂
Gd(GdCa)Ge₄O₁₂
Dy(DyCa)Ge₄O₁₂
Ho(HoCa)Ge₄O₁₂
Er(ErCa)Ge₄O₁₂
Tm(TmCa)Ge₄O₁₂
Yb(YbCa)Ge₄O₁₂
Lu(LuCa)Ge₄O₁₂
Y(YCa)Ge₄O₁₂
Gd(FeZn)Ge₄O₁₂
Y(MnFe)Ge₄O₁₂
Eu(MnFe)Ge₄O₁₂
Lu(MnFe)Ge₄O₁₂
Y₂₋ₓErₓCaGe₄O₁₂ (x = 0-2)
Y₂₋₂ₓCeₓCa₁₊ₓGe₄O₁₂ (x = 0-1)
Y₂₋ₓPrₓMnGe₄O₁₂ (x = 0-0.5)
Y(YCa₁₋ₓMnₓ)Ge₄O₁₂ (x = 0-1)
Y(YCa₁₋ₓZnₓ)Ge₄O₁₂ (x = 0-1)
Y(YCo₁₋ₓCaₓ)Ge₄O₁₂ (x = 0.25, 0.5)

A₄B₅C₄O₂₂ Perrierite-Group and Chevkinite-Group Materials

Embodiments of the oxygen ion transport materials have Formula II A₄^{x+}B₅^{y+}C₄^{z+}O₂₂²⁻ wherein 4x +5y+4z=44. As noted above, the labels A, B, and C represent distinct lattice sites in the material occupied by various elements. Here, however, the A-site elements, B-site elements, and C-site elements are selected to satisfy the valence equation 4x+5y+4z=44. In embodiments, the valence configuration (x, y, z) is (2, 4, 4), i.e. A₄²⁺B₅⁴⁺C₄⁴⁺O₂₂²⁻ (Formula IIA). In embodiments, the valence configuration (x, y, z) is (3, 3.2, 4), i.e., A₄³⁺B₅^{3.2+}C₄⁴⁺O₂₂² (Formula IIB). In embodiments, the valence configuration can be fractional due to the compositional variation on each site, for example (x, y, z) is (2.5, 3.6, 4), i.e., A₄^{2.5+}B₅^{3.6+}C₄⁴⁺O₂₂²⁻ (Formula IIC). In general, the A-site, B-site, and C-site elements may be selected from alkali metals, alkaline earth metals, transition metals, post-transition metals, metalloids, and lanthanoids. In embodiments, an actinide such as Th may be used, e.g., for an A-site element. Unless otherwise stated, more than one type of element may be present on a particular site. This includes, e.g., having 2, 3, 4, 5, 6, 7, etc. different types of elements on the A-site, the B-site, the C-site, or combinations thereof.

In embodiments, a single type of element is present on the A-site, two or three types of elements are present on the B-site, and a single type of element is present on the C-site. In embodiments, two types of elements are present on the A-site, two to five types of elements are present on the B-site, and a single type of element is present on the C-site. In embodiments, a single type of element is present on the A-site, a single type of element is present on the B-site, and a single type of element is present on the C-site.

Table 3, below, includes embodiments of oxygen ion transport materials having Formulas IIA, IIB, or IIC which may be used. In embodiments, the oxygen ion transport material has Formula IIA, wherein A is selected from Mg, Ca, Sr, Ba, Cu, Zn, and combinations thereof; B is selected from Ti, Zr, Hf, Ce, Re, Ir, and combinations thereof; and C is selected from Si, Ge, Sn, and combinations thereof. In embodiments, the oxygen ion transport material has Formula IIB, wherein A is selected from Al, Ga, Sc, Y, La, Ce, Pr, Nd, Sm, Eu, Gd, Tb, Dy, Ho, Er, Tm, Yb, Lu, and combinations thereof; B is selected from Mn, Ti, Zr, Hf, V, Fe, Co, Cr, Ru, Ir; and a combination of at least one 2+ element (selected from Fe, Co, Ni, Mg, Ca, Zn, Cu, Mn) and at least one 3+, 4+, or 5+ element (selected from Fe, Co, Ni, Mn, Al, Ga, Ti, Zr, Hf, Cr, Ru, Ir, Ge, V, Nb, W); and C is selected from Si, Ge, Sn, and combinations thereof. In embodiments, the oxygen ion transport material has Formula IIC, wherein A is a combination of at least one 2+ or 1+ element (selected from Mg, Ca, Sr, Ba, Cu, Zn, Na) and at least one 3+ or 4+ element (selected from Al, Ga, Sc, Y, La, Ce, Pr, Nd, Sm, Eu, Gd, Tb, Dy, Ho, Er, Tm, Yb, Lu, Th, Fe); B is a combination of at least one 2+ element (selected from Fe, Co, Ni, Mg, Ca, Zn, Cu, Mn), and at least one 3+, 4+, or 5+ element (selected from Fe, Co, Ni, Mn, Al, Ga, Ti, Zr, Hf, Cr, Ru, Ir, Ge, V, Nb, W); and C is selected from Si, Ge, Sn, Al, and combinations thereof.

TABLE 3
Embodiments of oxygen ion transport materials having Formula IIA, IIB, or IIC.

| Material | A-site elements | B-site elements | C-site elements |
|---|---|---|---|
| A₄²⁺B₅⁴⁺C₄⁴⁺O₂₂²⁻ | Mg, Ca, Sr, Ba, | Ti, Zr, Hf, Ce, Re, Ir | Si, Ge, Sn |
| (Formula IIA) | Cu, Zn | | |
| A₄³⁺B₅^{3.2+}C₄⁴⁺O₂₂²⁻ | Al, Ga, Sc, Y, La, | Mn, Ti, Zr, Hf, V, Fe, | Si, Ge, Sn |
| (Formula IIB) | Ce, Pr, Nd, Sm, | Co, Cr, Ru, Ir, or a | |
| | Eu, Gd, Tb, Dy, | combination of a 2+ | |
| | Ho, Er, Tm, Yb, | element (Fe, Co, Ni, | |
| | Lu | Mg, Ca, Zn, Cu, Mn) | |
| | | and a 3+ or 4+ or 5+ | |
| | | element (Fe, Co, Ni, | |
| | | Mn, Al, Ga, Ti, Zr, Hf, | |
| | | Cr, Ru, Ir, Ge, V, Nb, | |
| | | W) | |
| A₄^{2.5+}B₅^{3.6+}C₄⁴⁺O₂₂²⁻ | A combination of | V or a combination of | Si, Ge, Sn, Al |
| (Formula IIC) | a 2+ or 1+ element | a 2+ element (Fe, Co, | |
| | (Mg, Ca, Sr, Ba, | Ni, Mg, Ca, Zn, Cu, | |
| | Cu, Zn, Na) and a | Mn) and a 3+ or 4+ or | |
| | 3+ or 4+ element | 5+ element (Fe, Co, | |
| | (Al, Ga, Sc, Y, La, | Ni, Mn, Al, Ga, Ti, Zr, | |
| | Ce, Pr, Nd, Sm, | Hf, Cr, Ru, Ir, Ge, V, | |
| | Eu, Gd, Tb, Dy, | Nb, W) | |
| | Ho, Er, Tm, Yb, | | |
| | Lu, Th, Fe) | | |

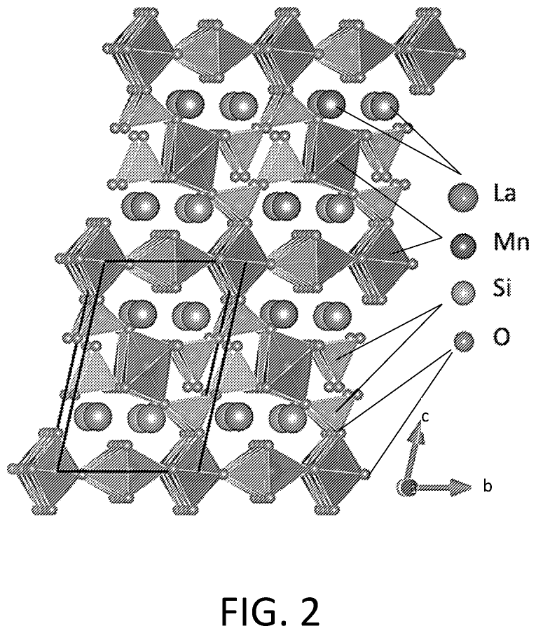

In embodiments, the oxygen ion transport material has Formula IIA, wherein A is Sr; B is selected from Zr, Ti, and combinations thereof; and C is Si. In embodiments, the oxygen ion transport material has Formula IIB, wherein A is selected from La, Pr, Nd, Sm, Ce, and combinations thereof; B is selected from Mn, V, Ti, Zn, Fe, Co, Ni, Al, Nb, Mg, Cr, and combinations thereof; and C is Si. In embodiments, the oxygen ion transport material has Formula IIB, wherein A is selected from La, Nd, and combinations thereof; B is selected from Mn, V, Ti, and combinations thereof; and C is Si. In embodiments, the oxygen ion transport material has Formula IIC, wherein A is Ce or a combination of at least two of Sr, Rare Earth Element (REE: Sc, Y, La, Ce, Pr, Nd, Sm, Eu, Gd, Tb, Dy, Ho, Er, Tm, Yb, Lu), Fe, Ca, Na, and Th; B is selected from Zr, Ti, Fe, Mg, Mn, Cr, Al, Ga, V, W, Nb and combinations thereof; and C is Si or a combination of Si and Al. An illustrative list of such species is shown in Table 4, below. The materials of Table 4 have been experimentally synthesized and confirmed to share the same crystal structure as La₄Mn₅Si₄O₂₂ (see FIG. 2).

TABLE 4
Additional embodiments of oxygen ion transport materials having Formula
IIA, IIB, or IIC. Note that the empty square symbol □ denotes a vacancy.
Formula IIA (A₄²⁺B₅⁴⁺C₄⁴⁺O₂₂²⁻)
Sr₄Ti₅Si₄O₂₂
Matsubaraite
Sr₄(ZrTi₄)Si₄O₂₂
Rengeite
Formula IIB (A₄³⁺B₅^{3.2+}C₄⁴⁺O₂₂²⁻)
La₄Mn₅Si₄O₂₂
La₄Ti₅Si₄O₂₂
A₄V₅Si₄O₂₂ (A = La, Pr, Nd)
A₄(V, Zn)₅Si₄O₂₂ (A = La, Pr, Nd, Ce)
A₄(Mg₂Ti₃)Si₄O₂₂ (A = La, Pr, Nd, Sm)
A₄(Fe₂Ti₃)Si₄O₂₂ (A = La, Nd, (Ce, La))
A(Ni₂Ti₃)Si₄O₂₂ (A = La₄, La₂Pr₂, LaPr₃, La_{0.6}Pr_{3.4}, La₂Nd₂, Pr₄, Nd₄, Sm₄, Sm₂Nd₂, Ce₄)
A(Co₂Ti₃)Si₄O₂₂ (A = La₄, La_{3.4}Pr_{0.6}, La₃Pr, La_{2.6}Pr_{1.4}, La₂Pr₂, Pr₄, Nd₄, Sm₄, Sm₂Nd₂, Ce₄,
Ce₂La₂, CeLa₃)
La₄Mn₃Ge_{5.2}Si_{0.8}O₂₂
La₄(FeCoTi₃)Si₄O₂₂
A(NiCoTi₃)Si₄O₂₂ (A = La₃Pr, La_{1.3}Pr_{2.7}, La₂Pr₂, Sm₂Nd₂)
A₄(FeAl₂Ti₂)Si₄O₂₂ (A = Pr, Nd, Ce)
Ce₄BSi₄O₂₂ (B = MgFe₂Ti₂, MgCr₂Ti₂, FeTi₄, Fe(Ti, Fe)₄, Fe_{1.5}AlTi_{2.5})
(Ce, La)₄(Fe (Ti, Fe, Mn)₂Ti₂)Si₄O₂₂
Dingdaohengite-(Ce)
(Ce, La)₄(Fe, Ti, Nb)₅Si₄O₂₂
Maoniupingite-(Ce)
Formula IIC (A₄^{x+}B₅^{y+}C₄^{z+}O₂₂²⁻ (4x + 5y + 4z = −44))
Ce₄(FeAlTi₃)(Si₃Al)O₂₂
(Ce₃Ca)(Fe(AlTi)Ti₂)Si₄O₂₂
(Ce₃Ca)(Fe(Ga, Ti)₂Ti₂)Si₄O₂₂
(Ce₃Sr)(Fe(AlTi)Ti₂)Si₄O₂₂
(Ce₃Sr)(Fe(Ga, Ti)₂Ti₂)Si₄O₂₂
(Ce_{3.4}Ca_{0.6})(Fe(Fe_{0.6}Al_{0.8}Ti_{0.7})Ti₂)Si₄O₂₂
(Ce_{3.7}Ca_{0.3})(Fe(Fe_{0.76}Al_{0.4}Ti_{0.85})Ti₂)Si₄O₂₂
(Ce_{3.8}Ca_{0.2})(Fe(Fe_{0.8}Al_{0.3}Ti_{0.9})Ti₂)Si₄O₂₂
(Ce_{1.2}La₁Nd_{0.15}Sr₁Ca_{0.5}Na_{0.15})₄((Zr_{0.5}Fe_{0.3}Mn_{0.2})(Ti_{1.3}Fe_{0.7})₂Ti₂)Si₄O₂₂
(La₃Sr)(Fe(GaTi)Ti₂)Si₄O₂₂
(La₃Ca)(Fe(AlTi)Ti₂)Si₄O₂₂
Pr₄(FeAl₂Ti₂)(Si₃Al)O₂₂
(Pr₃Ca)(Fe(AlTi)Ti₂)Si₄O₂₂
(Sr_{3.846}Ce_{0.154})(ZrTi_{3.68}Al_{0.1}Fe_{0.22})Si₄O₂₂
(Ce, Fe)₄(Fe, Ti, Nb)₅Si₄O₂₂
(La, Ca)₄V₅Si₄O₂₂
(Sr, REE)₄(Zr(Ti, Fe³⁺, Fe²⁺)₂Ti₂)Si₄O₂₂
Hezuolinite
(REE, Ca)₄(Fe²⁺(Ti, Fe²⁺, Mg, Fe³⁺)₂Ti₂)Si₄O₂₂
(Ce, La, Ca, Th)₄(Fe²⁺(Ti, Fe²⁺, Mg, Fe³⁺, Al)₂(Ti, Nb)₂)Si₄O₂₂
Dingdaohengite-(Ce)
(La, Ce, Ca)₄((Fe, Mn²⁺, Mg)Fe³⁺₂(Ti, Fe³⁺)₂)Si₄O₂₂
(La, Ce, Ca)₄((Fe²⁺, Mn)(Ti, Fe³⁺, Al)₄)Si₄O₂₂
(La, Ce, Ca)₄(Fe²⁺(Ti, Fe³⁺)₄)Si₄O₂₂
Perrierite-(La)
(Ce, La, Ca)₄(Fe²⁺ (Ti, Fe³⁺)₄)Si₄O₂₂
(REE, Ca)₄(Fe²⁺(Ti, Fe²⁺, Fe³⁺, Al)₂Ti₂)Si₄O₂₂
Perrierite-(Ce)
(Ce, Ca, Th)₄(Fe, Mg, Ti)₅Si₄O₂₂
(REE, Ca)₄(Fe²(Ti, Fe³⁺, Nb)₄)Si₄O₂₂
(REE, Ca)₄(Fe²(Ti, Fe³⁺, Fe²⁺, Al)₂Ti₂)Si₄O₂₂
(REE, Ca, Th)₄((Fe²⁺, Mg)(Fe²⁺, Ti, Fe³⁺)₂(Ti, Fe³⁺)₂)Si₄O₂₂
(REE, Ca, Na)₄((Fe²⁺, Mg²⁺, Ti²⁺)(Fe²⁺, Nb⁵⁺, Al³⁺)₂(Ti⁴⁺, Ti³⁺, Nb⁵⁺)₂)Si₄O₂₂
(REE, Ca, Na)₄((Fe²⁺)(Fe²⁺, Nb⁵⁺, Al³⁺)₂(Ti⁴⁺, Ti³⁺, Nb⁵⁺, Mg²⁺)₂)Si₄O₂₂
(Ce, La, Nd, Ca, Sr, Th, Na)₄((Fe²⁺, Mg, Mn²⁺)(Fe³⁺, Ti, Al, Zr, Nb)₂Ti₂)Si₄O₂₂
Chevkinite-(Ce)
(REE, Ca)₄((Fe²⁺, Mg)(Cr³, Fe³⁺)₂(Ti, Nb)₂)Si₄O₂₂
Polyakovite-(Ce)
(REE, Ca)₄((Fe³⁺, Ti, Fe²⁺, □)(Ti, Fe3⁺, Fe²⁺, Nb)₂Ti₂)Si₄O₂₂
Maoniupingite-(Ce)
(REE, Ca)₄((Mg, Fe²⁺)(Cr³⁺, Fe³⁺)₂(Ti, Nb)₂)Si₄O₂₂
Polyakovite-(Ce)
(Sr, La, Ce, Ca)₄(Fe(Ti, Zr)₂Ti₂)Si₄O₂₂
(Sr, REE)₄(Fe²⁺(Ti⁴⁺, Fe)₄)Si₄O₂₂
Strontiochevkinite
(Ce, La, Ca)₄(Mn²⁺(Ti, Fe³⁺)₃(Fe3⁺, Fe²⁺, Ti))Si₄O₂₂
(REE, Ca)₄(Mn²⁺(Ti, Fe³⁺)₃(Fe3⁺, Fe²⁺, Ti))Si₄O₂₂
(Ce, REE, Ca)₄((Mn, Fe²⁺)(Ti, Fe, Al)₄)Si₄O₂₂
Christofschäferite-(Ce)
(Sr, La, Ce, Ca)₄(Zr(Ti, Fe)₂Ti₂)Si₄O₂₂
Rengeite
(REE, Ca)₄(Mg(Fe³⁺, W, Al)₃□)Si₄O₂₀(OH)₂
Delhuyarite-(Ce)

Bi₂MO₄X Materials

Embodiments of the oxygen ion transport materials have Formula III, Bi₂MO₄X wherein M is selected from Rare Earth Elements and X is selected from halogens. In embodiments, M is selected from Y, La, Ce, Pr, Nd, Sm, Eu, Gd, Tb, Dy, Ho, Er, Tm, Yb, Lu, and combinations thereof and X is selected from F, Cl, Br, I, and combinations thereof. Each of these materials have been experimentally synthesized and confirmed to share the same crystal structure as Bi₂LaO₄Cl. Unless otherwise stated, more than one type of element M, X may be present on each relevant site as described above. However, in embodiments, a single type of element M is present and a single type of element X is present.

Selection of AB₂C₄O₁₂ and A₄B₅C₄O₂₂ materials which exhibit desirable oxygen ion transport properties may be guided by the following parameters including free volume, migration hop length, bulk thermodynamic stability, and valence state. These parameters, their calculations, and illustrative numeric values for each are described in the Example, below.

Other parameters to be used to identify AB₂C₄O₁₂ and A₄B₅C₄O₂₂ materials which exhibit desirable oxygen ion transport properties include the formation energy E_{f} of the dilute oxygen interstitial ion in the AB₂C₄O₁₂ or A₄B₅C₄O₂₂ material. Density functional theory (DFT) calculations may be used to determine E_{f} at a T=300K and Po₂=0.2 atm for a particular AB₂C₄O₁₂ or A₄B₅C₄O₂₂ material as described in the Example, below. In embodiments, the oxygen ion transport material is characterized by an E_{f} of not more than 1 eV under these conditions. This includes an E_{f} in a range of from 0 eV to 1 eV and from 0.5 eV to 1 eV.

Other parameters to be used to identify AB₂C₄O₁₂ and A₄B₅C₄O₂₂ materials which exhibit desirable oxygen ion transport properties include the migration energy Eₘ at a T=300K and Po₂=0.2 atm of the oxygen ion in the AB₂C₄O₁₂ or A₄B₅C₄O₂₂ material. Ab initio molecular dynamics (AIMD) simulations may be used to determine Eₘ under these conditions for a particular AB₂C₄O₁₂ or A₄B₅C₄O₂₂ material as described in the Example, below. In embodiments, the oxygen ion transport material is characterized by an Eₘ under these conditions of not more than 0.6 eV. This includes an Eₘ of not more than 0.5 eV, not more than 0.4 eV, not more than 0.3 eV, not more than 0.2 eV, not more than 0.1 eV, or 0 eV.

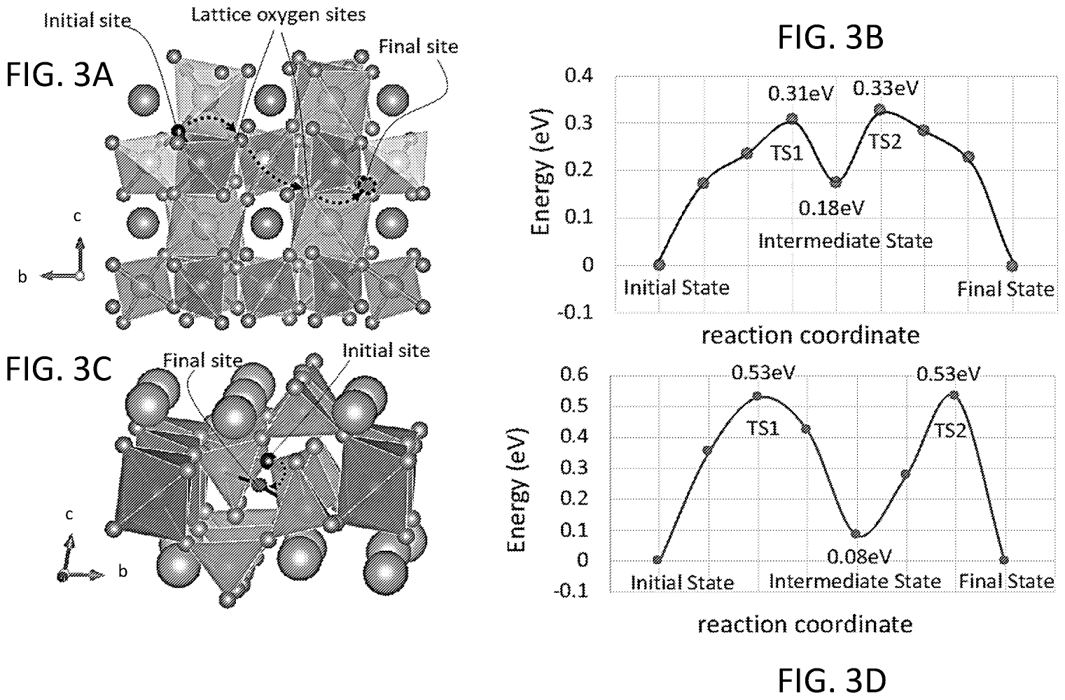

The present oxygen ion transport materials may be characterized by the mechanism by which the oxygen ion diffuses through the material. In embodiments, the diffusion is interstitial-mediated oxygen diffusion, which encompasses both interstitial and interstitialcy oxygen diffusion. (See FIGS. 3A, 3C.) In other embodiments, the diffusion is vacancy-mediated oxygen diffusion. Theoretical calculations similar to those described above, and in the Example, below, may be used to evaluate materials for desirable vacancy-mediated oxygen diffusion properties. AIMD simulations may be used to confirm the type of mechanism as described in the Example, below. The Bi₂MO₄X materials may be characterized by exhibiting vacancy-mediated oxygen diffusion.

The present oxygen ion transport materials may be synthesized by known techniques, such as the solid-state reaction heating techniques and the flux method referenced in the Example, below.

### Devices

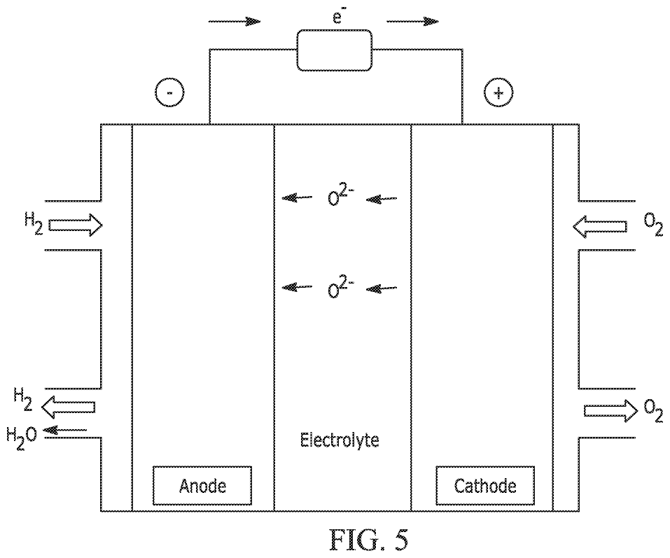

Although the present oxygen ion transport materials themselves are encompassed by the present disclosure, they may be incorporated into a variety of devices, which are also encompassed by the present disclosure. In general, any device comprising a source of oxygen ions may comprise that source, and also, any of the present oxygen ion transport materials in order to facilitate the transport of those oxygen ions within, to, or from the device. Thus, in embodiments, such a device comprises a source configured to generate oxygen ions via a redox reaction and an oxygen ion transport material through which the generated oxygen ions are transported. The source is a component, or a material thereof, in which, or on which (i.e., on a surface thereof), the redox reaction occurs. An illustrative redox reaction is O₂+4e⁻→2O²⁻, in which molecular oxygen is reduced to two oxygen ions. An illustrative source configured to generate oxygen ions via this reaction is an electrode in electrical communication with a source of electrons, e.g., from a counter electrode. In embodiments, the source and the oxygen ion transport material are different, distinct entities. However, in other embodiments, the oxygen ion transport material itself may also be the source of the oxygen ions. This may be achieved if the oxygen ion transport material is also electrically conductive. Illustrative devices are described below, with reference to FIGS. 5-10.

FIG. 5 depicts a schematic of a fuel cell comprising an oxygen ion transport material according to an illustrative embodiment. The fuel cell comprises an electrode (cathode), a counter electrode (anode) in electrical communication with the electrode, and an electrolyte between the electrode and the counter electrode. The electrode is the source of O²⁻, generated via the reduction of O₂, which is transported through the electrolyte to the counter electrode. An embodiment of the present oxygen ion transport materials may be used as the electrolyte, or a component thereof. In embodiments, the electrode of the fuel cell may comprise, or be composed of, an embodiment of the present oxygen ion transport materials. Aside from the use of the oxygen ion transport material in the device, other materials generally used in such fuel cells may be used. Fuel cells including additional components or adopting other configurations as compared to that of FIG. 5 may also be used.

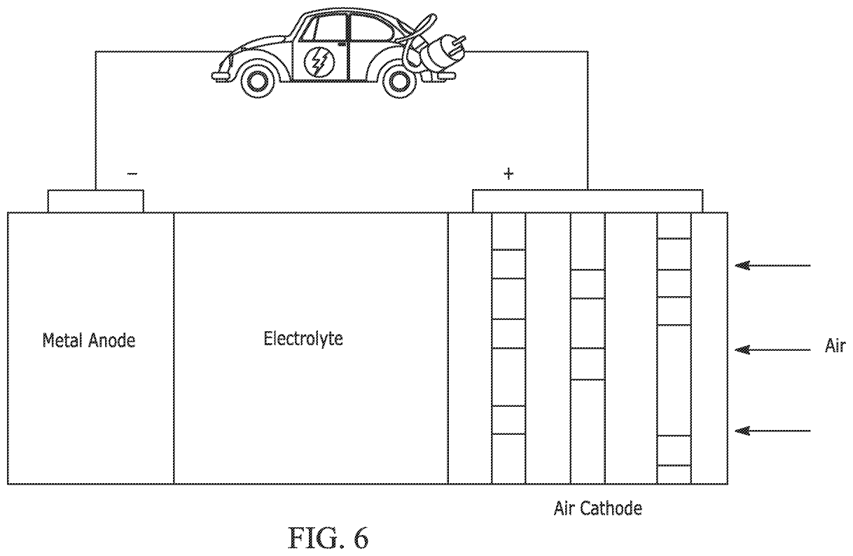

FIG. 6 depicts a schematic of a metal-air battery comprising an oxygen ion transport material according to an illustrative embodiment. The metal-air battery comprises an air electrode (air cathode), a counter electrode (metal anode) in electrical communication with the air electrode, and an electrolyte between the air electrode and the counter electrode. The air electrode is the source of O²⁻, generated via the reduction of O₂ in air, which is transported through the electrolyte to the counter electrode. An embodiment of the present oxygen ion transport materials may be used as the electrolyte, or a component thereof. In embodiments, the air electrode of the metal-air battery may comprise, or be composed of, an embodiment of the present oxygen ion transport materials. This includes the present oxygen ion transport materials being used in, or as, a membrane in contact with the air electrode. Aside from the use of the oxygen ion transport material in the device, other materials generally used in such metal-air batteries may be used. Metal-air batteries including additional components or adopting other configurations as compared to that of FIG. 6 may also be used.

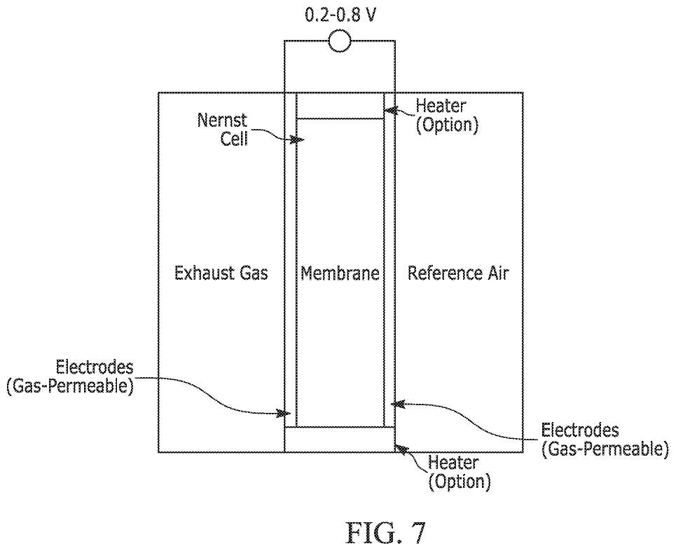

FIG. 7 depicts a schematic of a gas sensor comprising an oxygen ion transport material according to an illustrative embodiment. The gas sensor comprises a first electrode, a second electrode in electrical communication with the first electrode, and a membrane between the first and second electrodes. The first electrode is the source of O₂₋, generated via the reduction of O₂ from air, which is transported through the membrane to the second electrode. An embodiment of the present oxygen ion transport materials may be used as the membrane, or a component thereof. In embodiments, the first electrode of the gas sensor may comprise, or be composed of, an embodiment of the present oxygen ion transport materials. Aside from the use of the oxygen ion transport material in the device, other materials generally used in such gas sensors may be used. Gas sensors including additional components or adopting other configurations as compared to that of FIG. 7 may also be used.

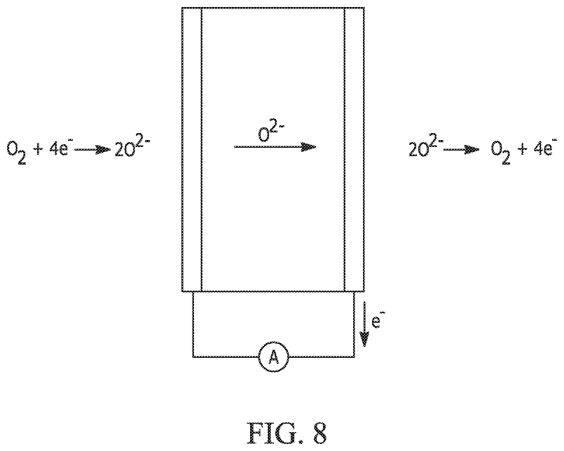

FIG. 8 depicts a schematic of a separation system comprising an oxygen ion transport material according to an illustrative embodiment. The separation system comprises an electrode, a counter electrode in electrical communication with the electrode, and membrane between the electrode and the counter electrode. The electrode is the source of O₂₋, generated via the reduction of O², which is transported through the membrane to the counter electrode. Other gases which may be present on the electrode side (e.g., N² in air), cannot pass through the membrane. Embodiments of the present oxygen ion transport materials may be used as the membrane, or a component thereof. In embodiments, the electrode and the counter electrode may not be necessary if the oxygen ion transport material is conductive. Aside from the use of the oxygen ion transport material in the device, other materials generally used in such separation systems may be used. Separation systems including additional components or adopting other configurations as compared to that of FIG. 8 may also be used. In embodiments, the separation system may be a component of a membrane reactor. By way of illustration, membrane reactors configured to carry out reactions such as the oxidative coupling of methane, the partial oxidation of methane, and the oxidative dehydrogenation of ethane may also comprise a separation system as described herein to facilitate the uniform distribution of pure oxygen along the axial length of such reactors.

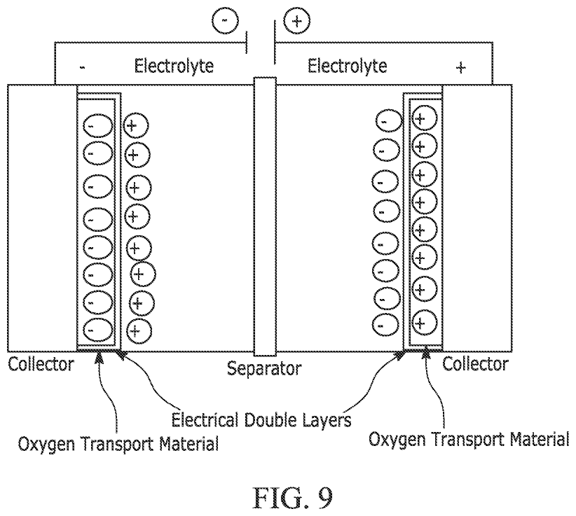

FIG. 9 depicts a schematic of a supercapacitor comprising an oxygen ion transport material according to an illustrative embodiment. The supercapacitor comprises a first electrode, a counter electrode in electrical communication with the electrode, an electrolyte between the electrode and the counter electrode, and a separator positioned in the electrolyte. The electrode is the source of O²⁻, generated via the reduction of O₂, which is transported through the electrolyte to the counter electrode. However, O²⁻ can also form an electrical double layer with cations near the electrode side. As shown in the figure, embodiments of the present oxygen ion transport materials may be used as the electrode, or a component thereof. Aside from the use of the oxygen ion transport material in the device, other materials generally used in such supercapacitors may be used. Supercapacitors including additional components or adopting other configurations as compared to that of FIG. 9 may also be used.

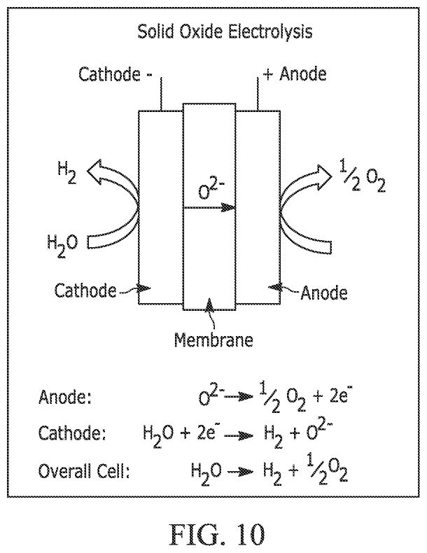

FIG. 10 depicts a schematic of a steam reactor for carrying out solid oxide electrolysis comprising an oxygen ion transport material according to an illustrative embodiment. The steam reactor comprises an electrode (cathode), a counter electrode (anode) in electrical communication with the electrode, and a membrane between the electrode and the counter electrode. The electrode is the source of O²⁻, generated via the reduction of water (steam), which is transported through the membrane to the counter electrode. An embodiment of the present oxygen ion transport materials may be used as the membrane, or a component thereof. In embodiments, the electrode of the reactor may comprise, or be composed of, an embodiment of the present oxygen ion transport materials. Aside from the use of the oxygen ion transport material in the device, other materials generally used in such steam reactors may be used. Steam reactors including additional components or adopting other configurations as compared to that of FIG. 10 may also be used.

### Methods

Methods of using any of the present oxygen ion transport materials and devices incorporating the materials are also encompassed by the present disclosure. In general, a method of transporting oxygen ions comprises exposing an embodiment of the present oxygen ion transport materials to a source of oxygen ions, wherein the oxygen ions are transported therethrough. The method may further comprise generating the oxygen ions from the source via a redox reaction. The method may further comprise steps involving the operation of the relevant device, e.g., the fuel cell, the metal-air battery, the gas sensor, the separation system, the supercapacitor, the steam reactor, etc.

### EXAMPLE

Oxide materials were examined using a variety of theoretical calculations as follows. Crystallographic information files (CIF files) from the Material Project databases were used to calculate the free volume, migration hop length, bulk thermodynamic stability, and the valence state of the oxides. By way of illustration, a search approach for interstitial-mediated oxygen diffusion materials is described below.

Voronoi analysis of the geometric structures was used to find the free volume. The shared corners and centers of shared edges of the Voronoi polyhedra were also used as initial guesses for the location of the oxygen interstitial (Oⁱ) site. The distance between the interstitial oxygen site and its nearest neighbors was used as the screening criterion. Specifically, for the distance between Oᵢ and its adjacent atom, subtracted by the ionic radius of the adjacent atom, the screening criterion was such that this distance is not smaller than 0.99 Å (i.e., distance≥0.99 Å) when the adjacent atom is a cation and not smaller than 0.88 A (i.e., distance≥0.88 Å) when the adjacent atom is oxygen, respectively. This criterion was used as a guide to determine if there is sufficient room for an Oᵢ atom in the material. The minimum distance between the oxygen interstitial sites was that this distance is less than or equal to 3 Å (i.e., minimum distance≤3 Å). Energy above convex hull of the oxide materials in the closed system and under air condition, i.e., open system, (300K, 0.2 atm O₂) was applied to evaluate the thermodynamic stability. In the closed system, the screening kept cases where the energy above hull was less than or equal to 100 meV/atom (i.e., energy above hull≤100 meV/atom). In the open system, the screening kept cases where the energy above hull was less than or equal to 200 meV/atom (i.e., energy above hull≤200 meV/atom). The valence state of the cations in the oxides was also analyzed and the screening criterion was that the valence state is smaller than its maximum oxidation state for at least one cation. Density functional theory (DFT) calculations were used to calculate the formation energy (E_{f}) of the interstitial oxygen ion in the oxides. Finally, analysis of the oxygen ion diffusion properties of the oxides was carried out using ab initio molecular dynamics (AIMD) simulation and the nudged elastic band (NEB) method. These methods were used to evaluate the migration energy (Eₘ) of the oxygen ion. The DFT calculation, AIMD simulation and the NEB calculation were performed by the Vienna Ab initio Simulation Package (VASP).

As another illustration, a search approach for vacancy-mediated oxygen diffusion materials is described below. The screening kept cases where the distances between the lattice oxygen sites were used as the screening criterion. Specifically, the nearest lattice oxygen distance was less than or equal to 3 Å (i.e., distance≤3 Å). Screening kept cases where the energy above convex hull of the oxide materials in the closed system was less than or equal to 100 meV/atom (i.e., energy above hull≤100 meV/atom). Then the CIF files were analyzed by the bond-valence method, which provided an estimate of the energy barrier (E_{b}) for the oxide-ion migration based on the geometry structure and composition of the materials. Screening kept cases where the estimated energy barrier was less than or equal to 1 eV. Finally, the defect formation energy and migration energy of oxygen vacancy with charge state 2+ (V\ddot{ₒ}) were studied at the DFT level.

The results of the theoretical calculations described above were used to arrive at two representative oxygen ion transport materials, ZrMn₂Ge₄O₁₂ and La₄Mn₅Si₄O₂₂. Table 5 also includes a few other representative oxygen ion transport materials. ZrMn₂Ge₄O₁₂ is an oxide material with the tetragonal space group P4/nbm (a=b=9.77 Å, c=9.83 Å; α=β=γ=90°. The bulk structure is shown in FIGS. 1A and 1B. Specifically, the structure of ZrMn₂Ge₄P₁₂ is composed of (001) layers of ZrO₈ square antiprisms and MnO₆ octahedra sharing edges, separated by layers of GeO₄ tetrahedra. The GeO₄ tetrahedra are linked into [Ge₄O₁₂]⁸⁻ rings, which are composed of four vertex-sharing GeO₄ tetrahedra. ZrMn₂Ge₄O₁₂ has been synthesized by solid-state reaction heating at 1125° C. (See Xu, D., Sale, M., Avdeev, M., Ling, C. D. & Battle, P. D. Dalt. Trans. 46, 6921-6933 (2017)).

La₄Mn₅Si₄O₂₂ is isostructural with the chevkinite and perrierite structures, crystallizes in the monoclinic space group (C2/m (a=11.26 Å, b=7.59 <, c=11.34 Å; α=74°. β=75.6°. γ=68.3°). The La₄Mn₅Si₄O₂₂ material displays sorosilicate Si₂O₇ groups which separate rutile-like sheets of edge-shared MnO₈ octahedra from single, isolated MnO₈ octahedra, as shown in FIG. 2. La₄Mn₅Si₄O₂₂ has been synthesized by solid-state reaction heating at 850° C. (See Gueho, C., Giaquinta, D., Mansot, J. L., Ebel, T. & Palvadeau, P. Chem. Mater. 7, 486-492 (1995)).

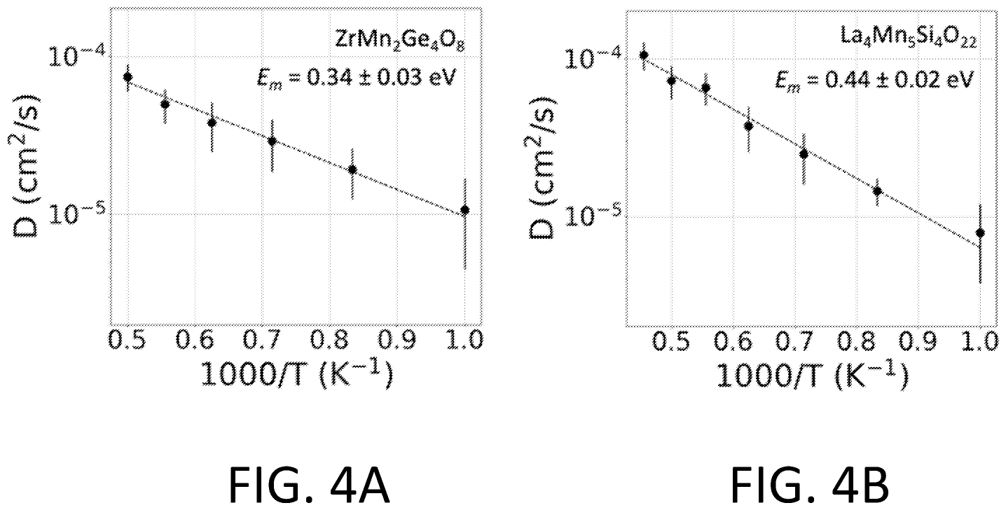

The formation energy of the oxygen interstitial (at ≈2% interstitial concentration) in ZrMn₂Ge₄O₁₂ and La₄Mn₅Si₄O₂₂ bulk structures were calculated under atmospheric condition (T=300K, Pₒ₂=0.2 atm) and are summarized in Table 5. Some calculations were performed for other materials as also shown in Table 5. Formation energies were studied with different DFT exchange and correlation functionals. These functionals consist of the generalized gradient approximation (GGA), GGA with Hubbard U correction (GGA+U), hybrid functional of Heyd, Scuseria and Ernzerhof (HSE06), and the strongly constrained and appropriately normed (SCAN) functional. Negative formation energies indicate that incorporating interstitial oxygen ions into the bulk structures is an energetically favorable process and oxygen interstitial defects are stable in the bulk structure. As noted above, the diffusion behavior of the oxygen ion in the bulk structures was studied by AIMD simulation. The migration pathway of oxygen ions in ZrMn₂Ge₄O₁₂ showed an interstitialcy (or “kick-out”) mechanism, in which an oxygen interstitial hops to an oxygen lattice site and the lattice oxygen hops to another interstitial site. The complete migration pathway is displayed in FIG. 3A, where initial and final interstitial sites are labeled. Two lattice oxygen sites are also labeled to illustrate the “kick-out” process. The energy profile of the diffusion pathway calculated by the NEB method shows that the migration barrier is surprisingly low, 0.33 eV (FIG. 3B). The migration barrier was also calculated by AIMD simulation (see Table 6, below). FIG. 4A shows the Arrhenius plot for ZrMn₂Ge₄O₈ of the AIMD-calculated oxygen-ion diffusivity versus the reciprocal of the temperature, with a calculated migration barrier of 0.34+0.03 eV, in excellent agreement with the NEB calculation. The error bars represent the numerical errors associated with the AIMD sampling and fitting Eₘ, but do not represent errors associated with the use of DFT. Notably, the very low migration barriers are comparable to those for Li ions in LiFePO₄, which is a commercial Li-ion battery cathode used in high-power applications. A similar plot is shown for La₄Mn₅Si₄O₂₂ in FIG. 4B. Therefore, the calculations show that the ZrMn₂Ge₄O₁₂, La₄Mn₅Si₄O₂₂, and other materials in Table 5 support the kind of fast oxygen ion transport previously only obtained for cations in the solid state.

TABLE 5
The formation energy of the oxygen interstitial E_{f} under atmospheric
condition (T = 300K, P_{O2} = 0.2 atm.)

| | E_{f}(eV) | E_{f}(eV) | E_{f}(eV) | E_{f} (eV) |
|---|---|---|---|---|
| | (GGA) | (GGA + U) | (HSE06) | (SCAN) |
| ZrMn₂Ge₄O₁₂ | −0.88 | 1.64 | 1.24 | −0.49 |
| La₄Mn₅Si₄O₂₂ | −0.55 | 0.74 | 0.73 | −0.11 |
| La₄Ti₅Si₄O₂₂ | | −1.62 | −1.72 | |
| CeMn₂Ge₄O₁₂ | −0.89 | | | |
| ZrCo₂Ge₄O₁₂ | 0.06 | | | |
| CeCo₂Ge₄O₁₂ | 0.33 | | | |
| Y(YMn)Ge₄O₁₂ | −0.56 | | | |
| Y(YCo)Ge₄O₁₂ | 0.40 | | | |
| La₄V₅Si₄O₂₂ | −1.01 | | | |
| Nd₄V₅Si₄O₂₂ | −1.41 | | | |

TABLE 6
The migration barrier Eₘ of the oxygen interstitial calculated by
the NEB method and the AIMD simulation using the GGA functional.

| | Eₘ (eV) (NEB) | Eₘ (eV) (AIMD) |
|---|---|---|
| ZrMn₂Ge₄O₁₂ | 0.33 | 0.34 ± 0.03 |
| La₄Mn₅Si₄O₂₂ | 0.53 | 0.44 ± 0.02 |
| La₄Ti₅Si₄O₂₂ | | 0.35 ± 0.08 |
| CeMn₂Ge₄O₁₂ | 0.54 | 0.57 ± 0.05 |

As shown in FIG. 3C, for La₄Mn₅Si₄O₂₂, the interstitial oxygen ion shows an interstitial diffusion pathway in which the oxygen interstitial directly hops in between two SiO₄ tetrahedra, without exchanging with the lattice oxygen. The initial and the final site of the interstitial are labeled in FIG. 3C. FIG. 3D shows the energy profile of the diffusion pathway calculated by the NEB method and FIG. 4B shows the Arrhenius plot of the AIMD-calculated oxygen-ion diffusivity versus the reciprocal of the temperature. Again, as summarized in Table 6, the calculated migration barrier for La₄Mn₅Si₄O₂₂ and other materials are surprisingly low.

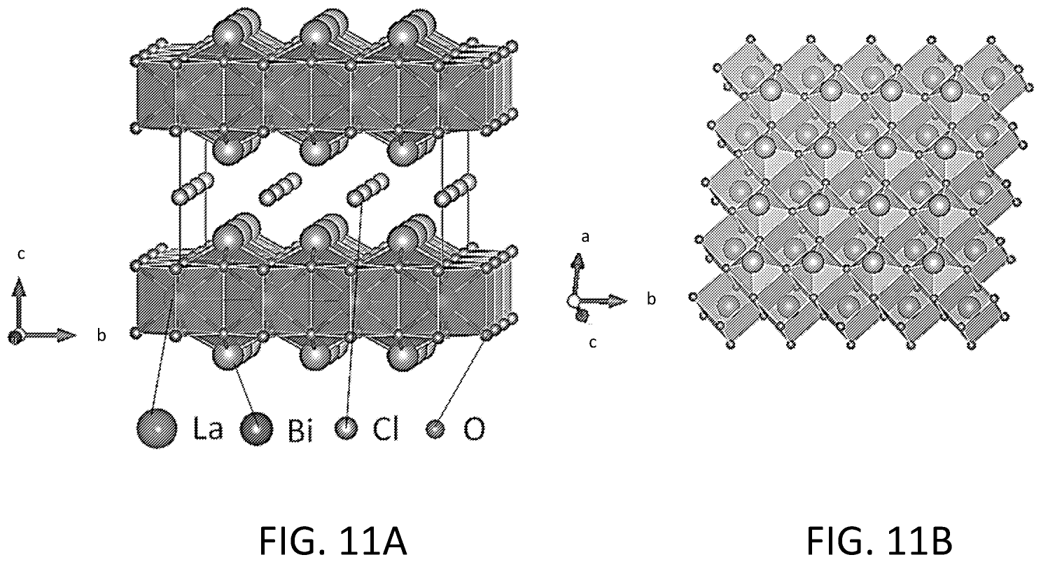

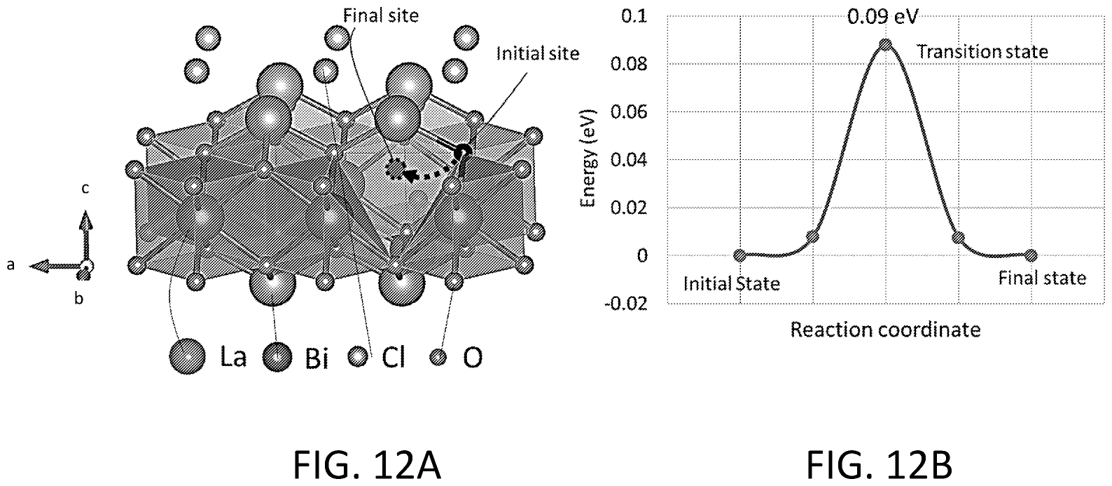

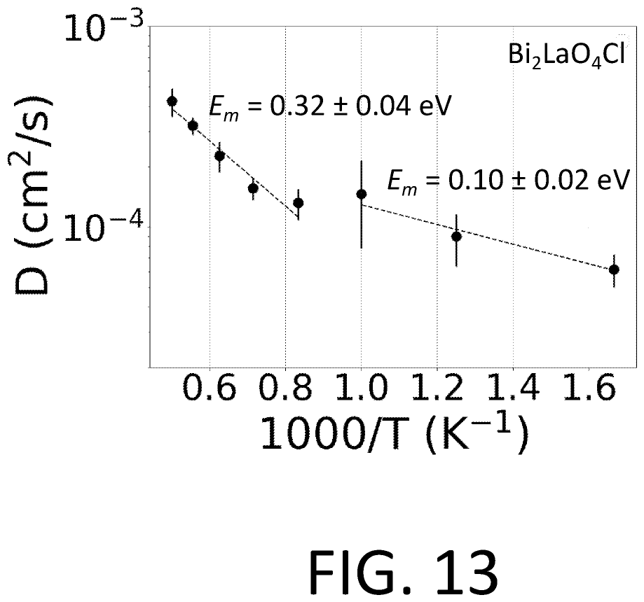

Similar theoretical calculations were performed to examine a vacancy-mediated oxygen transport material. The results of the theoretical calculations described above are presented below for the representative oxygen ion transport material Bi₂LaO₄Cl. Bi₂LaO₄Cl is a tetragonal structure with space group P4/mmm (a=b=3.99 Å, c=9.28 Å; α=β=γ=90°). The bulk structure is shown in FIG. 11. In the structure, [Bi₂LaO₄]⁺ layers are interweaved with a single layer of halogen atoms, forming a layered structure. Bi is 4-fold coordinated and La is 8-fold coordinated. Bi₂LaO₄Cl may be synthesized by the flux method at 1073K. (See A. Nakada, et al. J. Am. Chem. Soc. 6, 2491-2499 (2021)). The formation energy of the oxygen vacancy with charge state 2+ (V\ddot{ₒ}) at ≈1.6% vacancy concentration in Bi₂LaO₄Cl bulk structures was calculated at Pₒ₂=0.2 atm. The defect formation of V\ddot{ₒ} is 0.57 eV at 300K, −0.04 eV at 873K, and −0.43 eV at 1073K. The negative formation energy at 1073K indicates the formation of the V\ddot{ₒ} is energetically favorable during the synthesis process at Pₒ₂=0.2 atm. The diffusion behavior of the oxygen ion in the bulk structure was studied by AIMD simulation. The migration pathway of oxygen ions in Bi₂LaO₄Cl shows a vacancy-mediated mechanism, in which an oxygen hops from an oxygen lattice site to the vacant lattice oxygen. The complete migration pathway is displayed in FIG. 12A, where initial and final sites are labeled. The energy profile of the diffusion pathway calculated by the NEB method shows that the migration barrier is very low, 0.09 eV (FIG. 12B). The migration barrier was also calculated by fitting to temperature trends in AIMD simulation. FIG. 13 is the Arrhenius plot of the AIMD-calculated oxygen-ion diffusivity versus the reciprocal of the temperature. The data appears to show different barriers in different temperature regions and two linear fits were performed to identify one barrier in a high-temperature region and one in a low-temperature region. The calculated migration barrier from these linear fits is 0.32±0.04 eV in the high temperature region (T≥1200K), and 0.10 ±0.02 eV in the low temperature region (T≤1000K).

Oxygen ion transport materials were examined using a variety of experimental techniques as follows. Materials were synthesized using a solid-state reaction or flux method, as appropriate. The resulting synthesized powders were analyzed using X-ray diffraction (XRD) to verify the crystal structure matched to known records and to check for the presence of multiple phases. Powder samples were pressed and sintered at high temperature to achieve dense samples. To assess the presence of interstitial oxygen, dense, sintered samples of the oxygen ion transport materials ZrMn₂Ge₄O₁₂ and La₄Mn₅Si₄O₂₂, were examined using the electron probe micro-analyzer (EPMA) and iodometric titration methods. The chemical oxygen diffusivity and surface exchange coefficient of ZrMn₂Ge₄O₁₂, La₄Mn₅Si₄O₂₂, and Bi₂LaO₄Cl were studied using the electrical conductivity relaxation (ECR) method. Electrical conductivity transient was measured with abrupt oxygen partial pressure change. Electrical conductivity transient was measured at multiple temperature and oxygen partial pressure conditions. Oxygen diffusivity D_{chem} and surface exchange coefficient K_{chem} were obtained by fitting the normalized electrical conductivity relaxation curve to the 2-D diffusion equations.

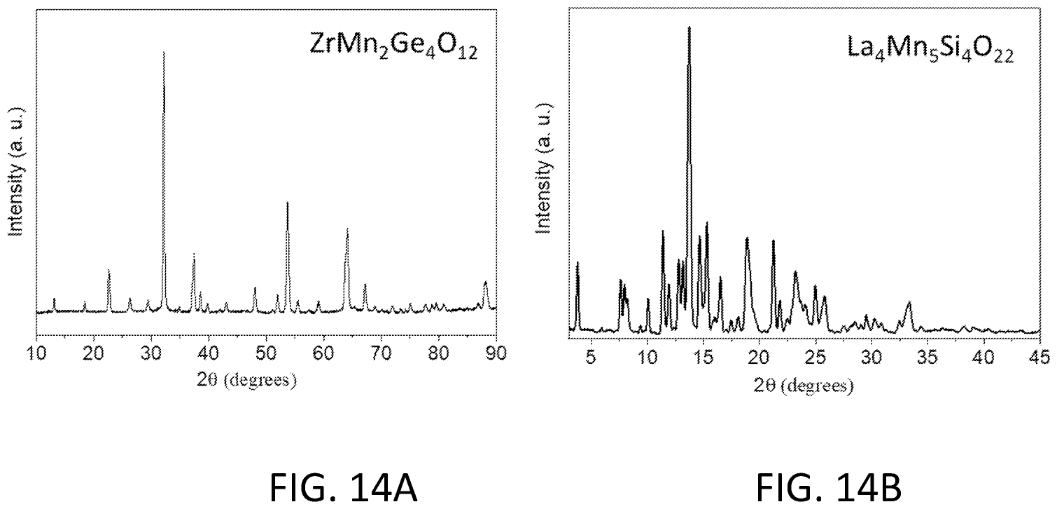

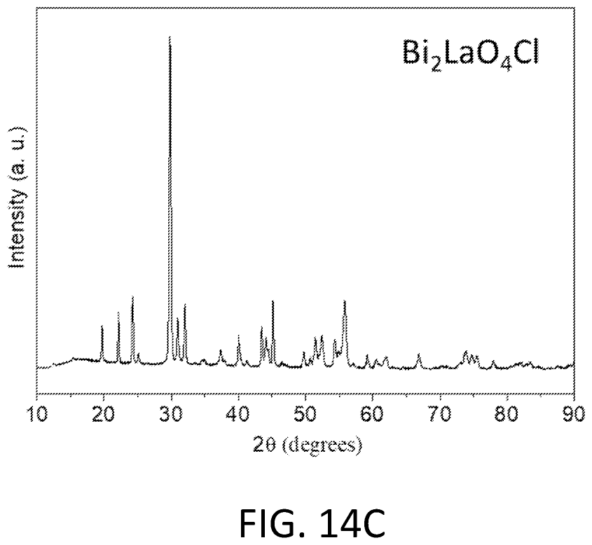

ZrMn₂Ge₄O₁₂ was synthesized through the solid-state reaction. Stoichiometric quantities of ZrO₂, MnCO₃, and GeO₂ were mixed and grinded using an alumina mortar and pestle for 1 hour. Then the reaction mixture was heated in an alumina crucible with a volume of 30 ml at 1050° C. for 6 hours with lid on. The grinding and heating process was repeated for 9 times and the ZrMn₂Ge₄O₁₂ powder was obtained. The crystalline structure of ZrMn₂Ge₄O₁₂ was examined by XRD as shown in FIG. 14A, indicating a crystalline sample with diffraction peaks in the expected positions.

La₄Mn₅Si₄O₂₂ was synthesized through the flux method. Stoichiometric quantities of La₂O₃, MnO₂, and SiO₂ were mixed with KCL flux. The flux-to-reactants mass ratio was 1.6:1. The reaction mixture was heated in an alumina crucible with a volume of 30 ml at 900° C. for 6 days with lid on. The sample was slow cooled down to 500° C. at a rate of 20° C./h and then cooled down to room temperature for 5 h at a rate of 95° C./h. The resultant powder was washed with deionized water for 7-10 times to dissolve the KCL flux and dried on a hot plate at 120° C. in air. La₄Mn₅Si₄O₂₂ powder was obtained and examined by XRD as shown in FIG. 14B, indicating a crystalline sample with diffraction peaks in the expected positions.

Bi₂LaO₄Cl was synthesized through the flux method. Stoichiometric quantities of Bi₂O₃, BiOCl, and La₂O₃ were mixed with CsCl flux with 95% molar concentration of the solvent. The reaction mixture was heated in an alumina crucible at 800° C. for 20 h with lid on. The sample was cooled down to room temperature at a cooling rate of 240 ° C./h. After cooling down, the synthesized sample was washed with deionized water for several times to remove the CsCl flux and dried on a hot plate at 120° C. in air. Bi₂LaO₄Cl powder was obtained and examined by XRD as shown in FIG. 14C, indicating a crystalline sample with diffraction peaks in the expected positions. Synthesized Bi₂LaO₄Cl powder was pressed and sintered at 1000° C.for 8 h in Ar atmosphere. The Bi₂LaO₄Cl pellet is stable below 700° C. while decomposed at higher temperature in air.

Synthesized ZrMn₂Ge₄O₁₂ powder was pressed and sintered at 1100° C. for 10 h in air and La₄Mn₅Si₄O₂₂ powder was pressed and sintered at 1050° C. for 24 h in air to achieve densification. Electron probe micro-analyser (EPMA) analysis was performed on the polished pellet, and the results are summarized in Table 7. From the EPMA analysis, the derived stoichiometries are ZrMn_{2.04}Ge_{3.79}O_{12+1.14} and La₄Mn_{4.69}Si_{4.03}O_{22+0.42} respectively, revealing the presence of Ge-vacancy and interstitial oxygen in ZrMn₂Ge₄O₁₂ and the presence of Mn-vacancy and interstitial oxygen in La₄Mn₅Si₄O₂₂. The presence of the interstitial oxygen validates the use of these compounds as oxygen ion transport materials for use in any of the devices described herein, including supercapacitors (for which capacitive charge storage is related to the oxygen interstitial concentration). Iodometric titration analysis was performed on the polished pellet of nominally La₄Mn₅Si₄O₂₂ and ZrMn₂Ge₄O₁₂, the derived stoichiometry was La₄Mn_{4.69}Si_{4.03}O_{22+0.47} and ZrMn2.04Ge_{3.79}O_{12+3.37} by assuming that the stoichiometry of cations is the same with the EPMA results. The existence of interstitial oxygen was confirmed by the EPMA and iodometric titration analysis.

TABLE 7
Atomic percentage measured by EPMA and the derived formula from EPMA
and Iodometric titration analysis compared with the ideal results.

| | Zr | Mn | Ge | O | Formula |
|---|---|---|---|---|---|
| Ideal | 5.26% | 10.53% | 21.05% | 63.16% | ZrMn₂Ge₄O₁₂ |
| EPMA | 5.01% | 10.21% | 19.00% | 65.79% | ZrMn_{2.04}Ge_{3.79}O_{12+1.14} |
| Iodometric titration | | | | | ZrMn_{2.04}Ge_{3.79}O_{12+3.37} |

| | La | Mn | Si | O | Formula |
|---|---|---|---|---|---|
| Ideal | 11.43% | 14.29% | 11.43% | 62.86% | La₄Mn₅Si₄O₂₂ |
| EPMA | 11.39% | 13.34% | 11.46% | 63.81% | La₄Mn_{4.69}Si_{4.03}O_{22+0.42} |
| Iodometric titration | | | | | La₄Mn_{4.69}Si_{4.03}O_{22+0.47} |

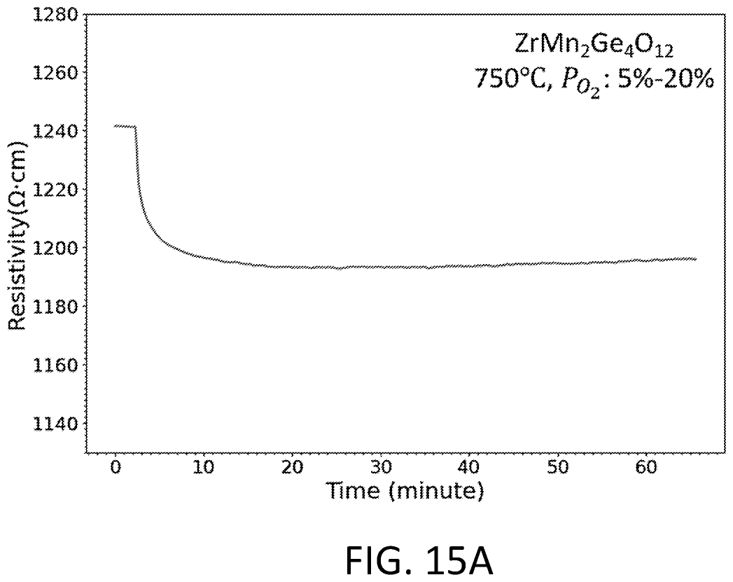

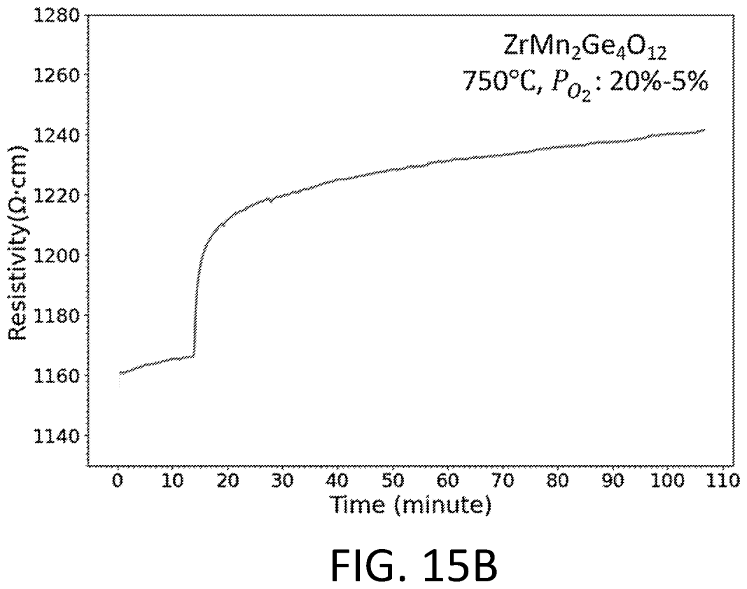

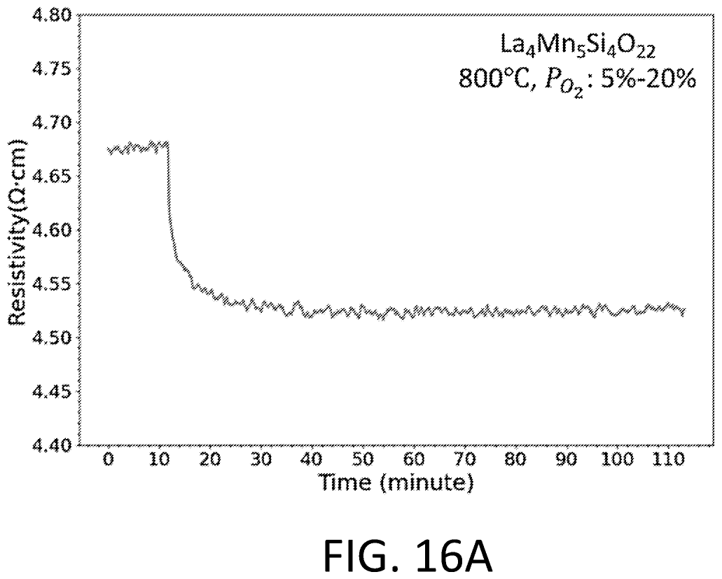

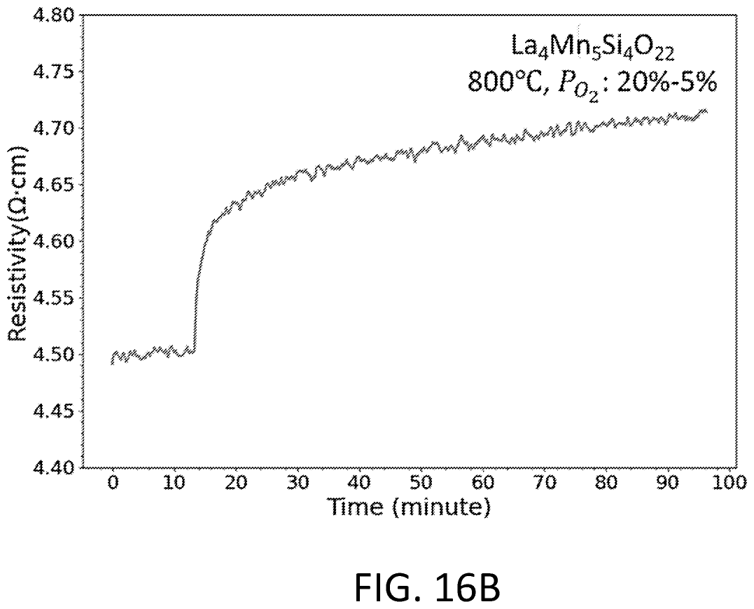

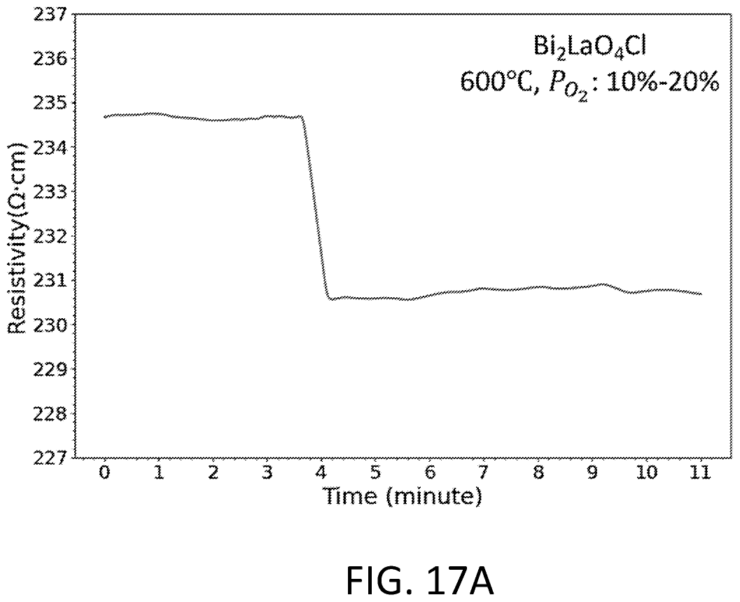

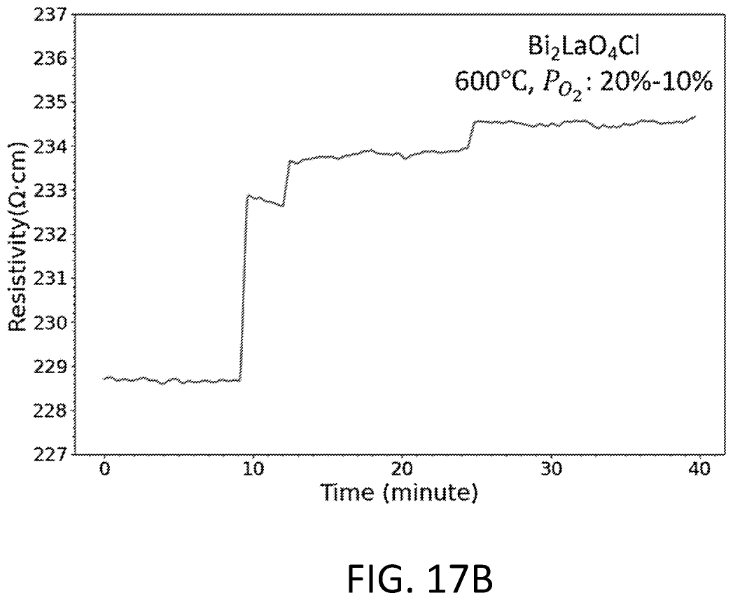

FIGS. 15A-15B show the electrical conductivity of the ZrMn₂Ge₄O₁₂ dense pellet, which was measured by switching oxygen partial pressure between 5% and 20% atm at 750° C. The resistivity changed from 1240 to 1195 Ω*cm within ˜5min. The fast response to the oxygen partial pressure indicates surprisingly fast oxygen exchange and diffusion. FIGS. 16A-16B show the electrical conductivity of the La₄Mn₅Si₄O₂₂ pellet, which was measured by switching oxygen partial pressure between 5% and 20% atm at 800° C. Again, surprisingly fast oxygen exchange and diffusion were observed. FIGS. 17A-17B show the electrical conductivity of the Bi₂LaO₄Cl pellet, which was measured by switching oxygen partial pressure between 10% and 20% atm at 600° C. Again, surprisingly fast oxygen exchange and diffusion were observed.

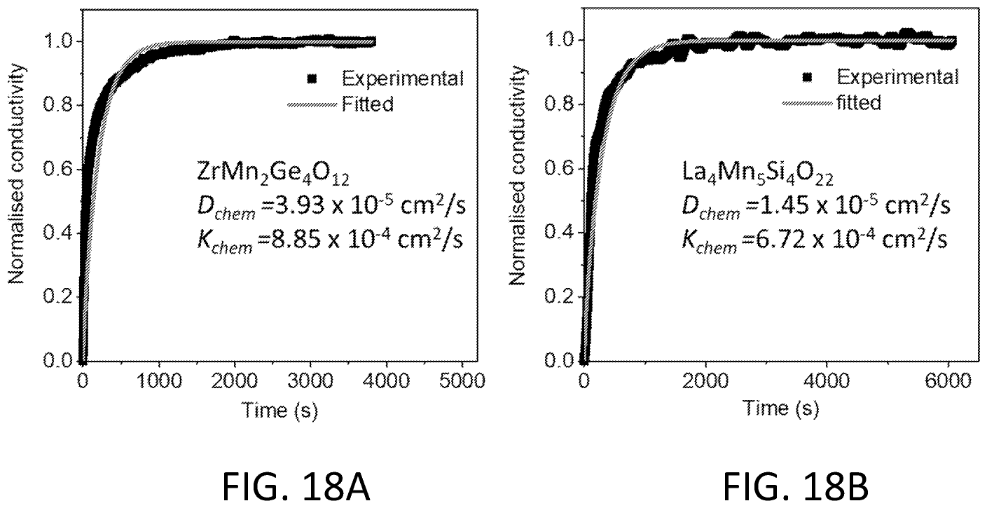

Oxygen diffusivity D_{chem} and surface exchange coefficient K_{chem} were obtained by fitting the normalized electrical conductivity relaxation curve to the 2-D diffusion equations. Fitting of the normalized electrical conductivity relaxation curve of ZrMn₂Ge₄O₁₂ with oxygen partial pressure changing from 5% to 20% at 750° C. is shown in FIG. 18A. Fitting of the normalized electrical conductivity relaxation curve of La₄Mn₅Si₄O₂₂ with oxygen partial pressure changing from 5% to 20% at 800° C. is shown in FIG. 18B. The derived D_{chem} and K_{chem} values are summarized in Table 8 and compared to the reference material LSCF, which is a representative mixed ionic and electronic conductor. The D_{chem} and K_{chem} of LSCF were obtained using the same method presented here. Both ZrMn₂Ge₄O₁₂ and La₄Mn₅Si₄O₂₂ exhibit higher D_{chem} and K_{chem} as compared to LSCF, demonstrating faster oxygen diffusion and surface exchange in the new oxide materials (ZrMn₂Ge₄O₁₂ and La₄Mn₅Si+O₂₂).

TABLE 8
Fitted oxygen diffusivity D_{chem} and surface exchange
coefficient K_{chem} of ZrMn₂Ge₄O₁₂ and La₄Mn₅Si₄O₂₂
compared with the reference material LSCF.

| | D_{chem} | K_{chem} |
|---|---|---|
| ZrMn₂Ge₄O₁₂, 800° C. | 3.93 × 10⁻⁵ cm²/s | 8.85 × 10⁻⁴ cm²/s |
| La₄Mn₅Si₄O₂₂, 750° C. | 1.45 × 10⁻⁵ cm²/s | 6.72 × 10⁻⁴ cm²/s |
| LSCF, 775° C. | 3.10 × 10⁻⁶ cm²/s | 3.19 × 10⁻⁴ cm²/s |

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

Each of the formulas disclosed herein encompass compounds in which the amounts of the elements may deviate from ideal, e.g., non-stoichiometric compounds. This deviation is inherent in the nature of chemical compounds, including the fact that the compounds are capable of allowing for oxygen transport so that some oxygen may be missing as vacancies or additional oxygen may be present during transport. For example, the deviation may be up to about 0.5 in cations. This includes up to about 0.4, up to about 0.3, up to about 0.2, and up to about 0.1. The deviation for oxygen may be, e.g., up to 25% of oxygen missing as oxygen vacancies or up to about 20% additional oxygen as interstitials. As a specific example, the formula ZrMn₂Ge₄O₁₂ encompasses the measured stoichiometries in Table 7, i.e., ZrMn_{2.04}Ge_{3.79}O_{12+3.37} and ZrMn_{2.04}Ge_{3.79}O_{12+1.14.} Similarly, the formula La₄Mn₅Si₄O₂₂ encompasses La₄Mn_{4.69}Si_{4.03}O_{22+0.42} and La₄Mn_{4.69}Si_{4.03}O_{22+0.47.}

All numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A device comprising:
a source configured to generate oxygen ions via a redox reaction; and
an oxygen ion transport material through which oxygen ions generated from the source are transported, the oxygen ion transport material having either:
Formula I A^{x+}B₂^{y+}C₄^{z+}O₁₂²⁻wherein x+2y+4z=24 and (x, y, z) is (4, 2, 4), (x, y, z) is (2, 1, 5), or (x, y, z) is (3, 2.5, 4);
Formula II A₄^{x+}B₅^{y+}C₄^{z+}O₂₂²⁻ wherein 4x+5y+4z=44 and (x, y, z) is (2, 4, 4) or (x, y, z) is (3, 3.2, 4) or (x, y, z) is (2.5,3.6, 4); or
Formula III Bi₂MO₄X;
wherein A, B, and C are independently selected from alkali metals, alkaline earth metals, transition metals, post-transition metals, metalloids, lanthanoids, P, Th, and combinations thereof, and
wherein M is selected from rare earth elements and combinations thereof and X is selected from halogens and combinations thereof.

2. The device of claim 1, wherein the oxygen ion transport material has Formula II wherein (x, y, z) is (3, 3.2, 4).

3. The device of claim 2, wherein A is selected from Al, Ga, Sc, Y, La, Ce, Pr, Nd, Sm, Eu, Gd, Tb, Dy, Ho, Er, Tm, Yb, Lu, and combinations thereof; B is selected from Mn, Ti, Zr, Hf, V, Fe, Co, Cr, Ru, Ir and a combination of at least one of Fe, Co, Ni, Mg, Ca, Zn, Cu, Mn and at least one of Fe, Co, Ni, Mn, Al, Ga, Ti, Zr, Hf, Cr, Ru, Ir, Ge, V, Nb, W; and C is selected from Si, Ge, Sn, and combinations thereof.

4. The device of claim 2, wherein A is selected from La, Pr, Nd, Sm, Ce, and combinations thereof; B is selected from Mn, V, Ti, Zn, Fe, Co, Ni, Al, Nb, Mg, Cr, and combinations thereof; and C is Si.

5. The device of claim 2, wherein A is selected from La, Nd, and combinations thereof; B is selected from Mn, V, Ti, and combinations thereof; and C is Si.

6. The device of claim 2, wherein the oxygen ion transport material is La₄Mn₅Si₄O₂₂; La₄Ti₅Si₄O₂₂; A₄(V, Zn)₅Si₄O₂₂ wherein A is La, Pr, Nd, or Ce; A₄(Mg₂Ti₃)Si₄O₂₂ wherein A is La, Pr, Nd, or Sm; A₄(Fe₂Ti₃)Si₄O₂₂ wherein A is La, Nd, or (Ce, La); A(Ni₂Ti₃)Si₄O₂₂ wherein A is La₄, La₂Pr₂, LaPr₃, La_{0.6}Pr_{3.4}, La₂Nd₂, Pr₄, Nd₄, Sm₄, Sm₂Nd₂, or Ce₄; A(Co₂Ti₃)Si₄O₂₂ wherein A is La₄, La_{3.4}Pr_{0.6,} La₃Pr, La_{2.6}Pr_{1.4}, La₂Pr₂, Pr₄, Nd₄, Sm₄, Sm₂Nd₂, Ce₄, Ce₂La₂, or CeLa₅; La₄Mn₃Ge_{5.2}Si_{0.8}O₂₂; La₄(FeCoTi₃)Si₄O₂₂; A(NiCoTi₃) Si₄O₂₂ wherein A is La₃Pr, La_{1.3}Pr_{2.7}, La₂Pr₂, or Sm₂Nd₂; A₄(FeAl₂Ti₂)Si₄O₂₂ wherein A is Pr, Nd, or Ce; Ce₄BSi₄O₂₂ wherein B is MgFe₂Ti₂, MgCr₂Ti₂, FeTi₄, Fe(Ti, Fe)₄, or Fe_{1.5}AlTi_{2.5}; Ce, La)₄(Fe (Ti, Fe, Mn)₂Ti₂)Si₄O₂₂; (Ce, La)₄(Fe (Ti, Fe, Mn)₂Ti₂)Si₄O₂₂; or a combination thereof.

7. The device of claim 2, wherein the oxygen ion transport material is La₄Mn₅Si₄O₂₂; La₄Ti₅Si₄O₂₂; La₄V₅Si₄O₂₂; Nd₄V₅Si₄O₂₂; or a combination thereof.

8. The device of claim 1, wherein the oxygen ion transport material has Formula I wherein (x, y, z) is (4, 2, 4).

9. The device of claim 8, wherein A is selected from Ti, Zr, Hf, Ce, Re, Ir, and combinations thereof; B is selected from Mg, Ca, Sr, Ba, Mn, Fe, Co, Ni, Cu, and combinations thereof; and C is selected from Si, Ge, Sn, and combinations thereof.

10. The device of claim 8, wherein A is selected from Zr, Ce, and combinations thereof; B is selected from Mn, Co, Ni, Cu, and combinations thereof; and C is Ge.

11. The device of claim 8, wherein A is selected from Zr, Ce, and combinations thereof; B is selected from Mn, Co, and combinations thereof; and C is Ge.

12. The device of claim 8, wherein the oxygen ion transport material is Ce(MnₓCo₂₋ₓ)Ge₄O₁₂ (x=0, 0.5, 1, 1.5, 2); Zr(MnₓCo₂₋ₓ)Ge₄O₁₂ (x=0, 0.5, 1, 1.5, 2); Ce(Mn_{1.5}Ni_{0.5})Ge₄O₁₂; Ce(Mn_{1.5}Cu_{0.5})Ge₄O₁₂; Ce(Co_{1.5}Ni_{0.5})Ge₄O₁₂; Ce(Co_{1.5}Cu_{0.5})Ge₄O₁₂; or a combination thereof.

13. The device of claim 8, wherein the oxygen ion transport material is ZrMn₂Ge₄O₁₂; CeMn₂Ge₄O₁₂; ZrCo₂Ge₄O₁₂; CeCo₂Ge₄O₁₂; or a combination thereof.

14. The device of claim 1, wherein the oxygen ion transport material has Formula I wherein (x, y, z) is (3, 2.5, 4).

15. The device of claim 14, wherein A is selected from Al, Ga, Sc, Y, La, Ce, Pr, Nd, Sm, Eu, Gd, Tb, Dy, Ho, Er, Tm, Yb, Lu, and combinations thereof; B is selected from a combination of at least one A-site element and at least one of Mg, Ca, Sr, Ba, Mn, Fe, Co, Ni, Cu, Zn; and a combination of at least two of Mg, Ca, Sr, Ba, Mn, Fe, Co, Ni, Cu, Zn; and C is selected from Si, Ge, Sn, and combinations thereof.

16. The device of claim 14, wherein A is selected from Y, Eu, Gd, Dy, Ho, Er, Tm, Yb, Lu, Tb, Ce, Pr, and combinations thereof; B is selected from a combination of at least one A-site element and at least one of Ca, Mn, Co; and a combination of at least two of Ca, Mn, Fe, Co, Cu, Sc, Zn; and C is Ge.

17. The device of claim 14, wherein the oxygen ion transport material is Y(YMn)Ge₄O₁₂; Y(YCo)Ge₄O₁₂; or a combination thereof.

18. The device of claim 1, wherein the oxygen ion transport material is La₄Mn₅Si₄O₂₂; LaTi₅Si₄O₂₂; La₄V₅Si₄O₂₂; Nd₄V₅Si₄O₂₂; ZrMn₂Ge₄O₁₂; CeMn₂Ge₄O₁₂; ZrCo₂Ge₄O₁₂; CeCo₂Ge₄O₁₂; Y(YMn)Ge₄O₁₂; Y(YCo)Ge₄O₁₂; or a combination thereof.

19. The device of claim 1, wherein the oxygen ion transport material is La₄Mn₅Si₄O₂₂; ZrMn₂Ge₄O₁₂; or a combination thereof.

20. The device of claim 1, wherein the device comprises an electrode, a counter electrode in electrical communication with electrode, and an electrolyte or a membrane between the electrode and the counter electrode, wherein the source is the electrode.

21. The device of claim 20, wherein the electrolyte, the electrode, or the membrane comprises the oxygen ion transport material.

22. The device of claim 20, wherein the device is a fuel cell, a gas sensor, or a separation system.

23. A method of using the device of claim 1, the method comprising transporting oxygen ions generated from the source through the oxygen ion transport material.

24. The method of claim 23. further comprising generating the oxygen ions via the redox reaction.
